(19) United States
(12) Patent Application Publication
(10) Pub. No.: US 2025/0298289 A1
(43) Pub. Date: Sep. 25, 2025

(54) CAMERA MODULE

(71) Applicant: Samsung Electro-Mechanics Co., Ltd., Suwon-si (KR)

(72) Inventor: Sung Ho KANG, Suwon-si (KR)

(73) Assignee: Samsung Electro-Mechanics Co., Ltd., Suwon-si (KR)

(21) Appl. No.: 18/917,426

(22) Filed: Oct. 16, 2024

(30) Foreign Application Priority Data
Mar. 22, 2024 (KR) 10-2024-0039823

(51) Int. Cl. G03B 17/12

(52) U.S. Cl. CPC G03B 17/12; G03B 2217/002

(57) ABSTRACT

A camera module includes a housing having an internal space, a carrier accommodated in the housing and configured to move in an optical axis direction, a first frame accommodated in the carrier and configured to move in a first axis direction, perpendicular to an optical axis and in a second axis direction, perpendicular to both the optical axis and a first axis, a stopper coupled to the carrier to cover the first frame, a case coupled to the housing to cover the internal space, and a damper member provided on the housing and the stopper, and including a first damper member, a second damper member, and a third damper member, which face a counterpart member in different directions, and at least one of the first damper member, the second damper member, and the third damper member is provided in the housing, and remainders thereof are provided in the stopper.

### CROSS-REFERENCE TO RELATED APPLICATIONS

This application claims the benefit under 35 USC § 119 (a) of Korean Patent Application No. 10-2024-0039823 filed on Mar. 22, 2024, in the Korean Intellectual Property Office, the entire disclosure of which is incorporated herein by reference for all purposes.

### BACKGROUND

### 1. Field

The following description relates to a camera module.

### 2. Description of Related Art

Recently, camera modules have been implemented in portable electronic devices, such as, but not limited to, smartphones, tablet personal computers (PCs), and laptops.

Most camera modules implemented in portable electronic devices have an autofocusing (AF) operation and an optical imaging stabilization (OIS) operation.

As the operations of camera modules have increased, the number of components mounted on the camera module has increased and the size and weight of camera modules have also increased accordingly.

However, the increase in the size and weight of camera modules has caused an increase in the amount of damage caused by impacts when collisions occur between components.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a housing having an internal space; a carrier, accommodated in the housing, and configured to move in an optical axis direction, with respect to the housing; a first frame, accommodated in the carrier, and configured to move in a first axis direction, perpendicular to an optical axis and in a second axis direction, perpendicular to both the optical axis and a first axis, with respect to the carrier; a stopper coupled to the carrier to cover the first frame; a case coupled to the housing to cover the internal space; and a damper member provided on the housing and the stopper, wherein the damper member comprises a first damper member, a second damper member, and a third damper member, which each face a respective counterpart member in different directions, and at least one of the first damper member, the second damper member, and the third damper member is provided on the housing, and remaining damper members of the first damper member, the second damper member, and the third damper member are provided on the stopper.

The first damper member may face a first counterpart member in the optical axis direction, the second damper member may face a second counterpart member in the first axis direction, and the third damper member may face a third counterpart member in the second axis direction.

The first damper member and the second damper member may be provided on the stopper, and the third damper member may be provided on the housing.

The stopper may include a body disposed to cover the first frame; and a fastening portion, coupled to the carrier, and extending from the body in the optical axis direction, wherein the first damper member may be disposed on the body, and may penetrate through the body in the optical axis direction, and the second damper member may be disposed on the body, and may penetrate through the fastening portion in the first axis direction.

A first side of the first damper member may face the case and a second side of the first damper may face the first frame.

A first side of the second damper member may face the housing and a second side of the second damper may face the first frame.

The third damper member may be formed to protrude from one side of the housing toward the internal space in the second axis direction, and the third damper member may face the carrier.

The first damper member, the second damper member, and the third damper member may each be provided as a separate member.

The first damper member, the second damper member, and the third damper member may be formed of an elastic material.

The camera module may include a lens barrel, coupled to the first frame, and comprising at least one lens, wherein the lens barrel may be configured to move in the first axis direction and the second axis direction together with the first frame, and wherein the lens barrel and the first frame may be configured to move in the optical axis direction together with the carrier.

In a general aspect, a camera module includes a housing unit having an internal space; a carrier accommodated in the housing unit; a first frame, accommodated in the carrier, and coupled to a lens barrel; a stopper coupled to the carrier in an optical axis direction; and a damper member provided on the housing unit and the stopper, wherein the damper member includes a first damper member and a second damper member disposed on the stopper and configured to face the housing unit and the first frame; and a third damper member disposed on the housing unit and configured to face the carrier.

The first damper member may face the housing unit and the first frame in the optical axis direction, and the first damper may include a first protrusion that protrudes from the stopper toward the housing unit in the optical axis direction and a second protrusion that protrudes from the stopper toward the first frame in the optical axis direction.

The second damper member may face the housing unit and the first frame in a first axis direction, perpendicular to an optical axis, and the second damper may include a third protrusion that protrudes from the stopper toward the housing unit in the first axis direction and a fourth protrusion that protrudes from the stopper toward the first frame in the first axis direction.

The third damper member may face the carrier in a second axis direction, perpendicular to an optical axis, and may protrude from one side of the housing unit toward the carrier in the second axis direction.

The first damper member, the second damper member, and the third damper member may each be provided as a separate member.

The stopper may include a body disposed to cover the first frame; and a plurality of fastening portions coupled to the carrier, and extending from each corner of the body in the optical axis direction, wherein the first damper member is disposed on the body, and the second damper member is disposed on at least a portion of the plurality of fastening portions.

Other features and aspects will be apparent from the following detailed description, the drawings, and the claims.

### BRIEF DESCRIPTION OF DRAWINGS

FIG. 1 is a perspective view of an example camera module, in accordance with one or more embodiments.

FIG. 2 is an exploded perspective view of an example camera module, in accordance with one or more embodiments.

FIG. 3 is an exploded perspective view of a focus adjustment unit, in accordance with one or more embodiments.

FIG. 4 is an exploded perspective view of a shake correction unit, in accordance with one or more embodiments.

FIG. 5 is a perspective view of a stopper, in accordance with one or more embodiments.

FIG. 6 is a side view of a stopper, in accordance with one or more embodiments.

FIG. 7 illustrates a coupled state of a stopper, in accordance with one or more embodiments.

FIG. 8 is a partial cross-sectional view of portion I-I′ of FIG. 1.

FIG. 9 is a partial cross-sectional view of portion II-II′ of FIG. 1.

FIG. 10 is a perspective view of a housing, in accordance with one or more embodiments.

FIG. 11 is a partial cross-sectional view of portion III-III′ of FIG. 1.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a camera module that alleviates impacts and damage when collision occurs between components.

An example camera module 1000, in accordance with one or more embodiments, may be used to capture an image or video of an external subject.

In one or more examples, the example camera module 1000 may be implemented in portable electronic devices, such as, but not limited to, smartphones.

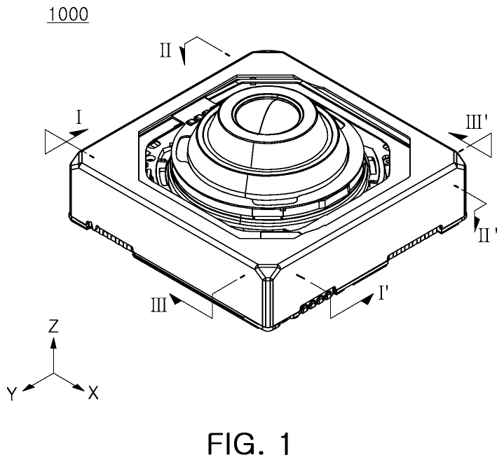

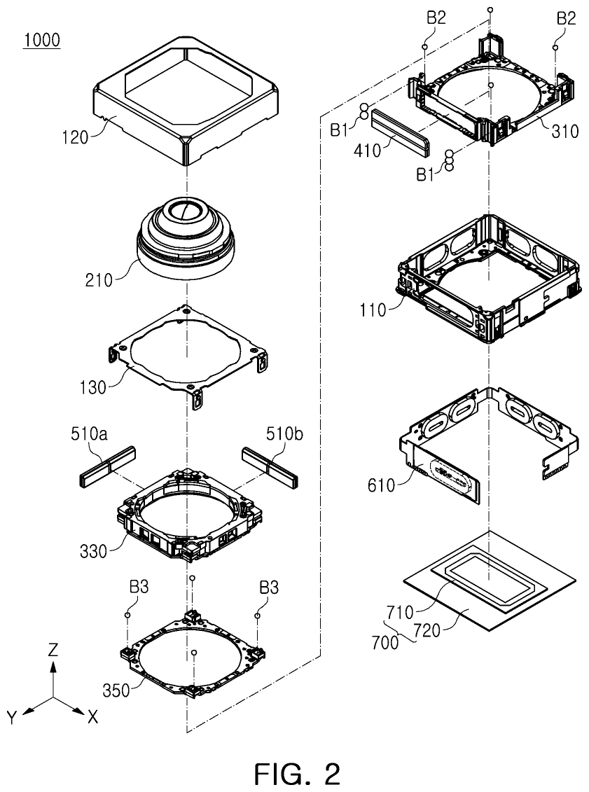

FIG. 1 is a perspective view of an example camera module, in accordance with one or more embodiments, and FIG. 2 is an exploded perspective view of an example camera module, in accordance with one or more embodiments.

Referring to FIGS. 1 and 2, the example camera module 1000, in accordance with one or more embodiments, may include a lens barrel 210, a lens driving device that moves the lens barrel 210, an image sensor module 700 that converts light incident through the lens barrel 210 into an electrical signal, and a housing unit (110, 120) that accommodates the lens barrel 210 and the lens driving device.

The housing unit may include a housing 110 and a case 120.

The lens barrel 210 may have a hollow cylindrical shape, and a plurality of lenses may be arranged inside the lens barrel 210.

The plurality of lenses may be mounted inside the lens barrel 210 in the optical axis direction (a Z-axis direction). The plurality of lenses may be provided in a desired number, and each lens may have the same or different optical properties.

The lens driving device may be a device that moves the lens barrel 210.

In an example, the lens driving device may include a focus adjustment unit 400 and a shake correction unit 500. The focus adjustment unit 400 may adjust the focus of the camera by moving the lens barrel 210 in the optical axis direction (the Z-axis direction), and the shake correction unit 500 may correct a shake during imaging by moving the lens barrel 210 in directions (the X-axis and Y-axis directions), perpendicular to the optical axis (the Z-axis).

The image sensor module 700 may be a device that converts light incident through the lens barrel 210 into an electrical signal.

In an example, the image sensor module 700 may include an image sensor 710 and a sensor substrate 720 on which the image sensor 710 is mounted.

The image sensor 710 may convert light incident through the lens barrel 210 into an electrical signal. For example, the image sensor 710 may be a charge coupled device (CCD) or a complementary metal-oxide semiconductor (CMOS), as non-limited examples.

The electrical signal converted through the image sensor 710 may be output as an image or a video through a display device of a portable electronic device.

The image sensor 710 may be electrically connected to the sensor substrate 720. For example, the sensor substrate 720 may be a printed circuit board (PCB).

The housing 110 may accommodate the lens barrel 210 and the lens driving device. In an example, the housing 110 may have an internal space, and the lens barrel 210 and the lens driving device may be accommodated in the internal space of the housing 110.

Additionally, an image sensor module 700 may be disposed below the housing 110. In an example, the sensor substrate 720 may be coupled to a bottom surface of the housing 110, and the image sensor 710 may be exposed to the internal space of the housing in a state in which the sensor substrate 720 is coupled to the housing 110.

In an example, a main substrate 610 that provides a driving signal to the focus adjustment unit 400 and the shake correction unit 500 may be disposed on the side of the housing 110. In an example, the main substrate 610 may be disposed to surround the side or sides of the housing 110.

As described below, a driving coil and a position sensor constituting the focus adjustment unit 400 and the shake correction unit 500 may be disposed on the main substrate 610.

The housing 110 may include an opening on a side surface thereof, and the driving coil and the position sensor may be disposed in the opening and exposed to the internal space of the housing 110.

The case 120 may be coupled to the housing 110 to cover the internal space, thereby protecting the components accommodated in the internal space.

Additionally, the case 120 may also have an operation of blocking electromagnetic waves. Accordingly, the case 120 may be formed of a metal material and may be grounded to a ground pad provided on the sensor substrate 720.

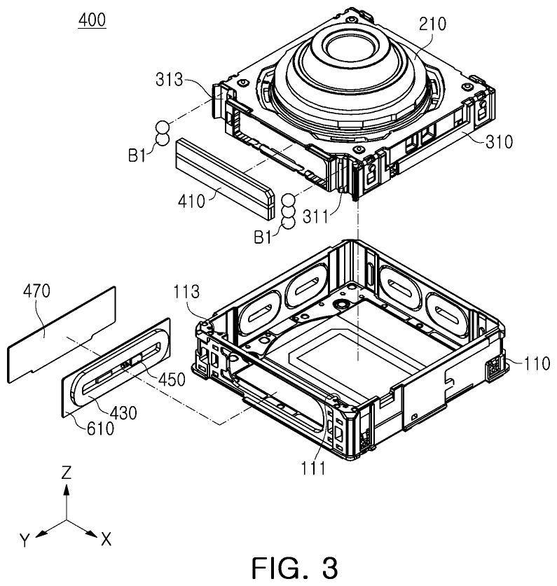

Hereinafter, the focus adjustment unit 400 of the lens driving device of the camera module 1000, in accordance with one or more embodiments, is described with reference to FIGS. 2 and 3.

FIG. 3 is an exploded perspective view of a focus adjustment unit, in accordance with one or more embodiments.

In an example, the focus adjustment unit 400 may include a carrier 310 that accommodates the lens barrel 210 and a focus adjustment driving unit that generates a driving force to move the lens barrel 210 and the carrier 310 in the optical axis direction (the Z-axis direction).

The carrier 310 may accommodate the lens barrel 210, and may be accommodated in the internal space of the housing 110.

The carrier 310 may be moved together with the lens barrel 210 in the optical axis direction (the Z-axis direction) with respect to the housing 110 based on a driving force generated by the focus adjustment driving unit.

The focus adjustment driving unit may include a focus adjustment magnet 410 and a focus adjustment coil 430.

In an example, the focus adjustment magnet 410 may be disposed on one surface of the carrier 310, and the focus adjustment coil 430 may be disposed on one surface of the housing 110 through the main substrate 610.

In an example, the focus adjustment coil 430 may be disposed on one surface of the housing 110 facing one surface of the carrier 310 on which the focus adjustment magnet 410 is disposed.

The focus adjustment magnet 410 and the focus adjustment coil 430 may face each other in one direction, perpendicular to the optical axis (the Z-axis) and may face each other directly through an opening of the housing 110.

In FIG. 3, a part of the main substrate 610 in which the focus adjustment coil 430 is disposed is illustrated as if it is separated from other parts. However, this is for convenience of description, and, in an example, the main substrate 610 may be provided as a single substrate.

When power is applied to the focus adjustment coil 430, the carrier 310 may be moved in the optical axis direction (the Z-axis direction) based on an electromagnetic influence between the focus adjustment magnet 410 and the focus adjustment coil 430.

In an example, the focus adjustment magnet 410 may be a moving member that is moved in the optical axis direction (the Z-axis direction) together with the carrier 310, and the focus adjustment coil 430 may be a fixed member that is fixedly disposed in the housing 110.

However, in an example, positions of the focus adjustment magnet 410 and the focus adjustment coil 430 may be interchanged.

A rolling member B1 may be disposed between the carrier 310 and the housing 110 to reduce frictional contact between the carrier 310 and the housing 110 when the carrier 310 is moved. For example, the rolling member B1 may be a plurality of ball members.

One or more rolling members B1 may be disposed on both sides of the focus adjustment magnet 410.

In an example, the number of rolling members B1 disposed on a first side of the focus adjustment magnet 410 may be greater than the number of rolling members B1 disposed on a second side of the focus adjustment magnet 410. In this example, the rolling member B1 disposed on one side of the focus adjustment magnet 410 may operate as a main guide, and the rolling member B1 disposed on the other side of the focus adjustment magnet 410 may operate as an auxiliary guide.

The carrier 310 may include respective first guide recesses 311 and 313 on both sides of the focus adjustment magnet 410, in which a portion of the rolling member B1 is accommodated.

In an example, the first guide recesses 311 and 313 may extend in the optical axis direction (the Z-axis direction), and the rolling member B1 may contact the first guide recesses 311 and 313 at one or two points.

The housing 110 may include second guide recesses 111 and 113 that face the first guide recesses 311 and 313, respectively. Another portion of the rolling member B1 may be accommodated in the second guide recesses 111 and 113.

In an example, the second guide recesses 111 and 113 may extend in the optical axis direction (the Z-axis direction), similar to the first guide recesses 311 and 313. Additionally, in an example, the rolling member B1 may contact the second guide recesses 111 and 113 at one or two points.

A first yoke 470 may be disposed on an outer surface of the main substrate 610. In an example, the yoke 470 may be formed of a magnetic material.

The first yoke 470 may face the focus adjustment magnet 410 with the focus adjustment coil 430 interposed therebetween, and thus, the first yoke 470 and the focus adjustment magnet 410 may face each other in one direction, perpendicular to the optical axis (the Z-axis).

Magnetic attraction may act between the first yoke 470 and the focus adjustment magnet 410 in a facing direction, that is, in a direction, perpendicular to the optical axis (the Z-axis).

Therefore, the carrier 310 may be supported in close contact with the housing 110 in a direction, perpendicular to the optical axis (the Z-axis), and the one or more rolling members B1 may be maintained in contact with the carrier 310 and the housing 110.

Additionally, the first yoke 470 may form a magnetic circuit with the focus adjustment magnet 410, thereby focusing magnetic force generated by the focus adjustment magnet 410.

In an example, the focus adjustment unit 400 may use a closed-loop control method of detecting a position of the lens barrel 210 and providing feedback.

Accordingly, the focus adjustment unit 400 may include a first position sensor 450.

The first position sensor 450 may detect the position of the lens barrel 210 in the optical axis direction (the Z-axis direction).

The first position sensor 450 may be disposed on one side of the housing 110 through the main substrate 610 along with the focus adjustment coil 430. In an example, the first position sensor 450 may be disposed inside or outside the focus adjustment coil 450.

The first position sensor 450 may be a magnetic sensor, for example, a Hall sensor.

In an example, the first position sensor 450 may be provided as another type of sensor.

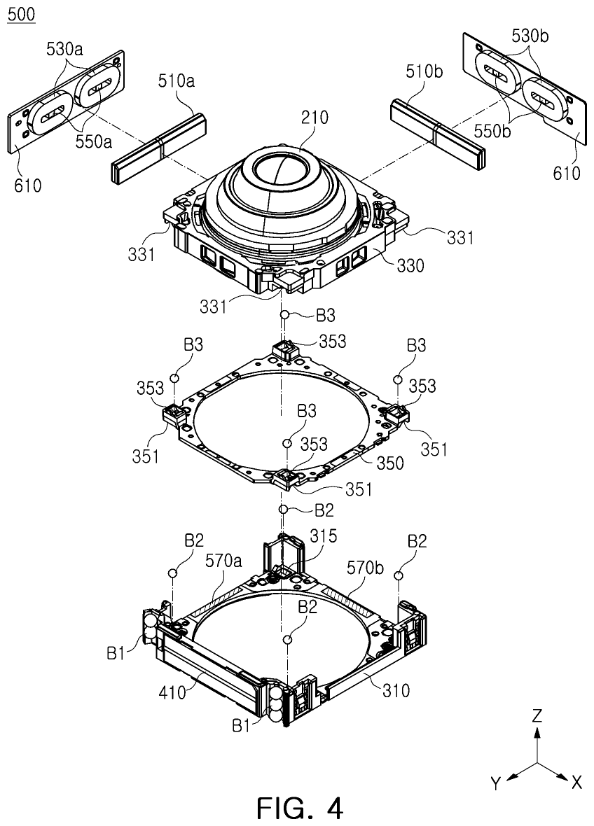

Next, the shake correction unit 500 of the lens driving device of the camera module 1000, in accordance with one or more embodiments, is described with reference to FIGS. 2 and 4.

FIG. 4 is an exploded perspective view of a shake correction unit, in accordance with one or more embodiments.

When shaking occurs due to a user's hand tremor when a video, etc., is captured, the shake correction unit 500 may compensate for the shake by giving a relative displacement corresponding to the shake to the lens barrel 210.

In accordance with one or more embodiments, the shake correction unit 500 may include a first frame 330 and a second frame 350 that guide s movement of the lens barrel 210 and a shake correction driving unit that generates a driving force to move the first frame 330 and the second frame 350 in directions (the X-axis and Y-axis directions), perpendicular to the optical axis (the Z-axis).

The first frame 330 and the second frame 350 may be accommodated in the carrier 310. In an example, the first frame 330 and the second frame 350 may be accommodated in the carrier 310 in order in the optical axis direction (the Z-axis direction).

Additionally, the lens barrel 210 may be inserted and fixed to the first frame 330.

The first frame 330 and the second frame 350 may be moved together with the lens barrel 210 in directions (the X-axis and Y-axis directions), perpendicular to the optical axis (the Z-axis) with respect to the carrier 310 based on a driving force generated by the shake correction driving unit.

In an example, one of the first frame 330 and the second frame 350 may be moved in a first axis direction (the X-axis direction), perpendicular to the optical axis (the Z-axis), and the other may be moved in a second axis direction (the Y-axis direction), perpendicular to both the first axis direction (the X-axis direction), the optical axis (the Z-axis), and the first axis (the X-axis).

The shake correction driving unit may include a shake correction magnet and a shake correction coil.

In an example, the shake correction driving unit may include a first magnet 510a and a first coil 530a that generate a driving force in the first axis direction (the X-axis direction) and a second magnet 510b and a second coil 530b that generate a driving force in the second axis direction (the Y-axis direction).

In an example, the first magnet 510a and the second magnet 520b may be disposed on two mutually perpendicular side surfaces of the first frame 330. Accordingly, the first frame 330 may be moved in the first axis direction (the X-axis direction) and the second axis direction (the Y-axis direction).

In an example, the first coil 530a and the second coil 530b may be disposed in the housing 110 through the main substrate 610. For example, the first coil 530a and the second coil 530b may be disposed on two side surfaces of the housing 110 facing two mutually perpendicular side surfaces of the first frame 330 on which the first magnet 410a and the second magnet 510b are disposed.

The shake correction magnet and shake correction coil may generate a driving force in a facing direction.

Accordingly, the first magnet 510a and the first coil 530a may be arranged to face each other in the first axis direction (the X-axis direction), and the second magnet 510b and the second coil 530b may be arranged to face each other in the second axis direction (the Y-axis direction).

In an example, the first magnet 510a and the second magnet 510b may be moving members that move in directions (the X-axis and Y-axis directions), perpendicular to the optical axis (the Z-axis) together with the first frame 330, and the first coil 530a and the second coil 530b may be fixed members fixedly disposed in the housing 110.

However, in an example, the positions of the first magnet 510a and the first coil 530a and the positions of the second magnet 510b and the second coil 530b may be interchanged.

In accordance with one or more embodiments, a plurality of ball members may be disposed between the first frame 330 and the second frame 350 and between the second frame 350 and the carrier 310.

The plurality of ball members may guide movement of the first frame 330 or the second frame 350, and may maintain a gap between the first frame 330, the second frame 350, and the carrier 310.

The plurality of ball members may include a first ball member B2 disposed between the second frame 350 and the carrier 310. In a non-limited example, the first ball member B2 may include three or three or more ball members. However, this is only an example, and the first ball member B2 may include fewer than three balls.

The first ball member B2 may guide movement of the second frame 350 in the first axis direction (the X-axis direction).

In an example, since the first frame 330 is supported by the second frame 350 and the lens barrel 210 is fixed to the first frame 330, when the second frame 350 moves in the first axis direction (the x-axis direction), the lens barrel 210 and the first frame 330 may be moved along with the second frame 350 in the first axis direction (the X-axis direction).

The second frame 350 may include a third guide recess 351 in which a portion of the first ball member B2 is accommodated on a surface facing the carrier 310 in the optical axis direction (the Z-axis direction).

Additionally, the carrier 310 may be provided with a fourth guide recess 315 in which another portion of the first ball member B2 is accommodated on the surface facing the second frame 350 in the optical axis direction (the Z-axis direction). The fourth guide recess 315 may face the third guide recess 351 in the optical axis direction (the Z-axis direction).

The third guide recess 351 and the fourth guide recess 315 may extend in the first axis direction (the X-axis direction).

Therefore, when a driving force is generated in the first axis direction (the X-axis direction), the first ball member B2 may roll in the first axis direction (the X-axis direction) along the third guide recess 351 and the fourth guide recess 315, and movement of the first ball member B2 in the second axis direction (the Y-axis direction) may be restricted.

The plurality of ball members may include a second ball member B3 disposed between the first frame 330 and the second frame 350. In a non-limited example, the second ball member B3 may include three or three or more ball members.

The second ball member B3 may guide a movement of the first frame 330 in the second axis direction (the Y-axis direction).

In an example, since the lens barrel 210 is fixed to the first frame 330, when the first frame 330 is moved in the second axis direction (the Y-axis direction), the lens barrel 210 may be moved together with the first frame 330 in the second axis direction (the Y-axis direction).

The first frame 330 may include a fifth guide recess 331 in which a portion of the second ball member B3 is accommodated on a surface facing the second frame 350 in the optical axis direction (the Z-axis direction).

Additionally, the second frame 350 may include a sixth guide recess 353 in which another portion of the second ball member B3 is accommodated on the surface facing the first frame 330 in the optical axis direction (the Z-axis direction). The sixth guide recess 353 may face the fifth guide recess 331 in the optical axis direction (the Z-axis direction).

The fifth guide recess 331 and the sixth guide recess 353 may extend in the second axis direction (the Y-axis direction).

Therefore, when a driving force is generated in the second axis direction (the Y-axis direction), the second ball member B3 may roll in the second axis direction (the Y-axis direction) along the fifth guide recess 331 and the sixth guide recess 353, and movement of the second ball member B3 in the first axis direction (the X-axis direction) may be restricted.

In an example, the second frame 350 may be omitted, and the first frame 330 may be accommodated in the carrier 310 with the lens barrel 210 fixed.

In this example, the plurality of ball members disposed between the first frame 330 and the carrier 310 may roll in the first axis direction (the X-axis direction) when a driving force is generated in the first axis direction (the X-axis direction), and may roll in the second axis direction (the Y-axis direction) when a driving force is generated in the second axis direction (the Y-axis direction).

Additionally, to this end, the guide recesses provided on the surfaces of the first frame 310 and the carrier 310 facing each other in the optical axis direction (the Z-axis direction) may have a shape that does not restrict a movement direction of the plurality of ball members on the plane, perpendicular to the optical axis (the Z-axis).

In an example, a plurality of yokes 570a and 570b may be disposed on the carrier 310. In an example, the plurality of yokes 570a and 570b may be formed of a magnetic material.

The plurality of yokes 570a and 570b may be arranged to face the first magnet 510a and the second magnet 510b disposed on the first frame 330 in the optical axis direction (the Z-axis direction).

Magnetic attraction may act between the plurality of yokes 570a and 570b and the first magnet 510a and the second magnet 510b in a direction facing each other, that is, in the optical axis direction (the Z-axis direction).

Accordingly, the first frame 330 and the second frame 350 may be pressed against the carrier 310 in the optical axis direction (the Z-axis direction), and the first ball member B2 and the second ball member B3 may each maintain contact with the first frame 330, the second frame 350, and the carrier 310.

In an example, the shake correction unit 300 may use a closed-loop control method of detecting the position of the lens barrel 210 and providing feedback.

Accordingly, the shake correction unit 500 may include a second position sensor 550a and a third position sensor 550b.

The second position sensor 550a and the third position sensor 550b may detect the positions of the lens barrel 210 in the first axis direction (the X-axis direction) and the second axis direction (the Y-axis direction).

The second position sensor 550a and the third position sensor 550b may be disposed on one side of the housing 110 through the main substrate 610 together with the first coil 530a and the second coil 530b, respectively. In an example, the second position sensor 550a and the second position sensor 550b may be disposed inside or outside the first coil 530a and the second coil 530b.

In an example, the second position sensor 550a and the third position sensor 550b may be magnetic sensors, for example, Hall sensors.

In an example, the second position sensor 550a and the third position sensor 550b may be provided as different types of sensors.

In an example, the camera module 1000, in accordance with one or more embodiments, may further include a stopper 130 to absorb impacts transmitted to internal components due to external impacts, etc. and to prevent the first frame 330 and the second frame 350 from escaping from, or detaching from, the carrier 310.

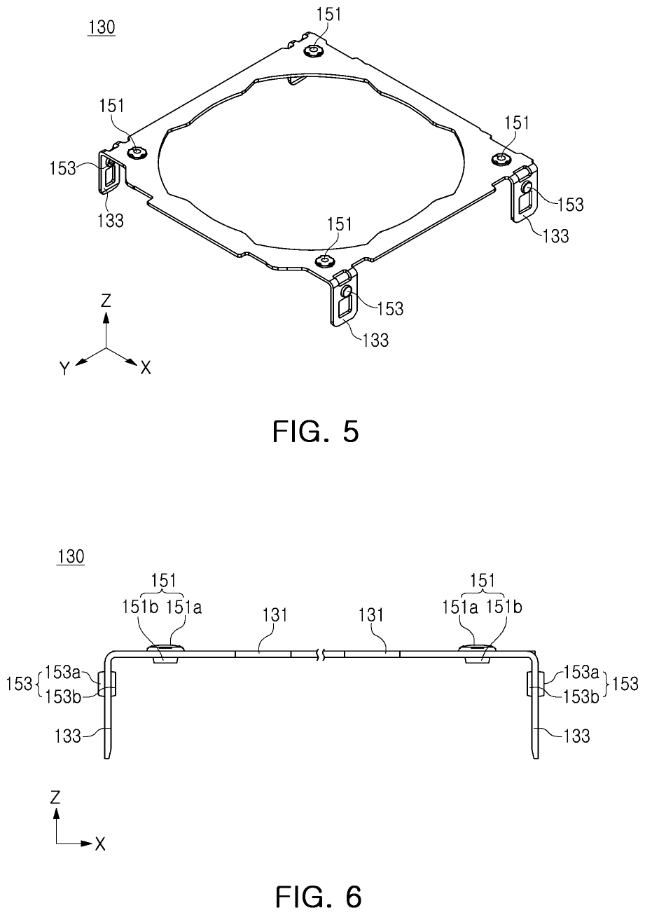

Next, the stopper 130, in accordance with one or more embodiments, is described with reference to FIGS. 5 to 9.

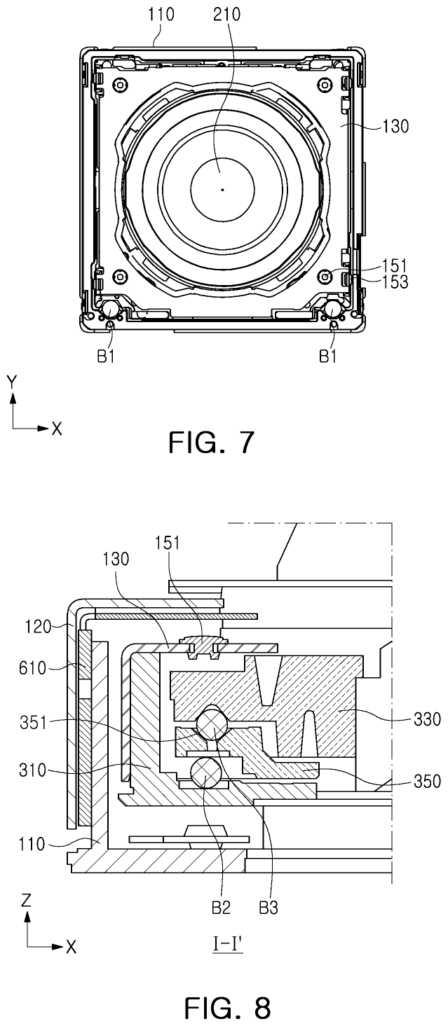

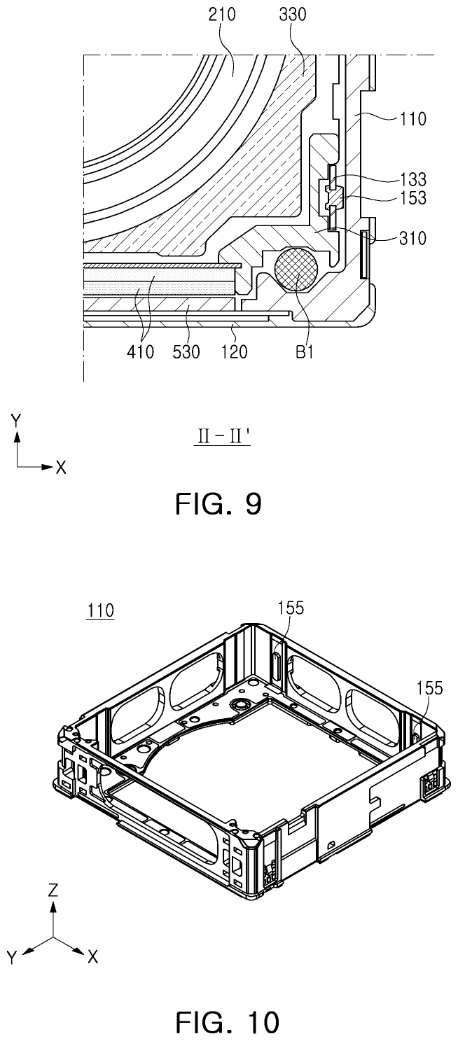

FIG. 5 is a perspective view of a stopper, in accordance with one or more embodiments, FIG. 6 is a side view of the stopper, in accordance with one or more embodiments e, and FIG. 7 is a view illustrating a coupled state of the stopper, in accordance with one or more embodiments. Additionally, FIG. 8 is a partial cross-sectional view of portion I-I′ of FIG. 1, and FIG. 9 is a partial cross-sectional view of portion II-II′ of FIG. 1.

The stopper 130 may be coupled to the carrier 310 to cover at least a portion of an upper surface of the first frame 330.

The stopper 130 may include a body 131 disposed to cover an upper surface of the first frame 330 and a fastening portion 133 that extends from each corner of the body 131 in the optical axis direction (the Z-axis direction).

In an example, the fastening portion 133 may be provided at the corners of two sides of the body 131 facing each other in the first axis direction (the X-axis direction) for coupling to the carrier 310.

The stopper 130 may be coupled to the carrier 310 through the fastening portion 133. In an example, the fastening portion 133 may be fitted into a recess included in the carrier 130.

In an example, the stopper 130 may cover the first frame 330 and the second frame 350 accommodated in the internal space of the carrier 310, and since the stopper 130 is coupled to the carrier 310, the first frame 330 and the second frame 350, etc. accommodated in the internal space of the carrier 310 may be prevented from being separated from the carrier 310 due to an external impact or the like.

Additionally, the stopper 130 may include damper members 151 and 153 to absorb impacts transmitted to components when external impacts occur.

In an example, the damper members 151 and 153 may be insert-injection molded into the stopper 130. Alternatively, the damper members 151 and 153 may be manufactured separately from the stopper 130 and then bonded to the stopper 130 with an adhesive or the like or may be fitted into a hole provided in the stopper 130.

The damper members 151 and 153 may be disposed between adjacent components in which a collision may occur. Accordingly, when an external impact occurs, adjacent components may not collide with each other and may collide with the damper members 151 and 153.

Additionally, the damper members 151 and 153 may be formed of an elastic or ductile material to efficiently absorb impacts when colliding with components.

In accordance with one or more embodiments, the damper members 151 and 153 may be provided in at least one of the body 131 and the fastening portion 133 of the stopper 130.

Referring to FIG. 6 and the like, the damper members 151 and 153 may include one or more of a first damper member 151 provided in the body 131 of the stopper 130 and a second damper member 153 provided in the fastening portion 133 of the stopper 130. In an example, the damper members 151 and 153 may include both the first damper member 151 and the second damper member 153.

In an example, the first damper member 151 and the second damper member 153 may be separate members. Accordingly, a binding force between the body 131 and the first damper member 151 and between the fastening portion 133 and the second damper member 153 may be improved.

Additionally, the first damper member 151 and the second damper member 153 may be separate members from a third damper member 155, which is described below.

There may be one or more first damper member 151. Preferably, the first damper member 151 may be provided in plural.

The first damper member 151 may be disposed to penetrate through the body 131 in the optical axis direction (the Z-axis direction), thereby absorbing impacts between adjacent components in the optical axis direction (the Z-axis direction).

In an example, the first damper member 151 may include a first protrusion 151a that protrudes toward the upper side (the +Z direction) of the body 131 and a second protrusion 151b that protrudes toward the lower side (-Z direction) of the body 131.

The first protrusion 151a may directly face a counterpart member, for example, the case 120 disposed above the stopper 130 in the optical axis direction (the Z-axis direction), and the second protrusion 151b may directly face the first frame 330 disposed below the stopper 130 in the optical axis direction (the Z-axis direction).

Therefore, when an impact is applied to the camera module 1000 in the optical axis direction (the Z-axis direction), a direct collision between the first frame 330 and the case 120 may be prevented by the first damper member 151.

Additionally, the first damper member 151 may also restrict a movement range of the carrier 310.

Referring to FIG. 8, when the carrier 310 moves in the optical axis direction (the Z-axis direction), the first protrusion 151a of the first damper member 151 may first contact the case 120. Accordingly, a collision between components due to movement of the carrier 310 in the optical axis direction (the Z-axis direction) may be prevented and the movement range of the carrier 310 may be restricted.

The second damper member 153 may be provided in plural. In an example, one second damper member 153 may be provided on each of the fastening portions 133 provided on different sides of the body 131, and preferably, may be provided on all fastening portions 133.

The second damper member 153 may be disposed to penetrate through the fastening portion 133 in the first axis direction (the X-axis direction), thereby absorbing impacts between adjacent components in the first axis direction (the X-axis direction).

In an example, the second damper member 153 may include a third protrusion 153a that protrudes to the outside (+X direction) of the fastening portion 133 and a fourth protrusion 153b that protrudes to the inside (-X direction) of the fastening portion 133.

The third protrusion 153a may directly face a counterpart member, for example, the housing 110 disposed on the outside of the stopper 130 in the first axis direction (the X-axis direction), and the fourth protrusion 153b may directly face a counterpart member, for example, the first frame 330 disposed on the inside of the stopper 130 in the first axis direction (the X-axis direction).

Therefore, when impacts are applied to the camera module 1000 in the first axis direction (the X-axis direction), a direct collision between the housing 110 and the first frame 330 may be prevented by the second damper member 153.

Additionally, the camera module 1000, in accordance with one or more embodiments, may further include the third damper member 155 that absorbs impacts applied in the second axis direction (the Y-axis direction).

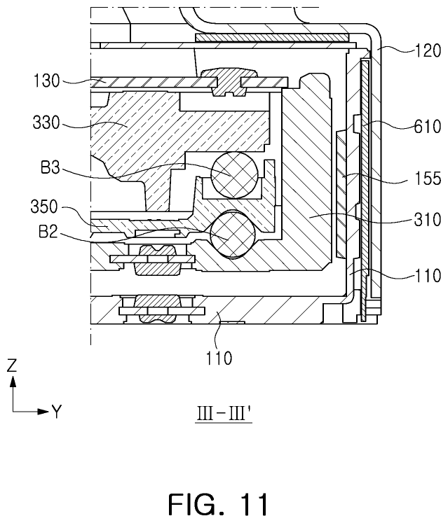

FIG. 10 is a perspective view of an example housing 110, in accordance with one or more embodiments, and FIG. 11 is a partial cross-sectional view of portion III-III′ of FIG. 1.

Referring to FIG. 10, the third damper member 155 may be provided in the housing 110.

In an example, the third damper member 155 may be insert-injection molded into the housing 110. Alternatively, the third damper member 155 may be manufactured separately from the housing 110 and then coupled to the housing 110.

In an example, the third damper member 155 may be provided on at least one of two sides of the housing 110 facing each other in the second axis direction (the Y-axis direction).

The third damper member 155 may be formed to protrude toward the internal space of the housing 110 from at least one of the two sides of the housing 110 facing in the second axis direction (the Y-axis direction).

There may be one or more third damper member 155. In an example, the third damper member 155 may be provided in plural. For example, the plurality of third damper members 155 may be spaced apart from each other with an opening therebetween on one side of the housing 110 in the first axis direction (the X-axis direction).

The third damper member 155 may be formed to protrude from one side of the housing 110 toward the internal space of the housing 110 (-Y direction).

The third damper member 155 may directly face a counterpart member, for example, the carrier 310 disposed inside the housing 110 in the second axis direction (the Y-axis direction).

Therefore, when an impact is applied to the camera module 1000 in the second axis direction (the Y-axis direction), a direct collision between the housing 110 and the carrier 310 may be prevented by the third damper member 155.

The camera module, in accordance with one or more embodiments, may alleviate impacts and damage when a collision occurs between components.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a housing having an internal space;
a carrier, accommodated in the housing, and configured to move in an optical axis direction, with respect to the housing;
a first frame, accommodated in the carrier, and configured to move in a first axis direction, perpendicular to an optical axis and in a second axis direction, perpendicular to both the optical axis and a first axis, with respect to the carrier;
a stopper coupled to the carrier to cover the first frame;
a case coupled to the housing to cover the internal space; and
a damper member provided on the housing and the stopper,
wherein the damper member comprises a first damper member, a second damper member, and a third damper member, which each face a respective counterpart member in different directions, and
at least one of the first damper member, the second damper member, and the third damper member is provided on the housing, and remaining damper members of the first damper member, the second damper member, and the third damper member are provided on the stopper.

2. The camera module of claim 1, wherein the first damper member faces a first counterpart member in the optical axis direction, the second damper member faces a second counterpart member in the first axis direction, and the third damper member faces a third counterpart member in the second axis direction.

3. The camera module of claim 2, wherein the first damper member and the second damper member are provided on the stopper, and the third damper member is provided on the housing.

4. The camera module of claim 3, wherein:
the stopper comprises:
a body disposed to cover the first frame; and
a fastening portion, coupled to the carrier, and extending from the body in the optical axis direction,
wherein the first damper member is disposed on the body, and penetrates through the body in the optical axis direction, and the second damper member is disposed on the body, and penetrates through the fastening portion in the first axis direction.

5. The camera module of claim 4, wherein a first side of the first damper member faces the case and a second side of the first damper faces the first frame.

6. The camera module of claim 4, wherein a first side of the second damper member faces the housing and a second side of the second damper faces the first frame.

7. The camera module of claim 3, wherein:
the third damper member is formed to protrude from one side of the housing toward the internal space in the second axis direction, and
the third damper member faces the carrier.

8. The camera module of claim 1, wherein the first damper member, the second damper member, and the third damper member are each provided as a separate member.

9. The camera module of claim 1, wherein the first damper member, the second damper member, and the third damper member are formed of an elastic material.

10. The camera module of claim 1, further comprising:
a lens barrel, coupled to the first frame, and comprising at least one lens,
wherein the lens barrel is configured to move in the first axis direction and the second axis direction together with the first frame, and
wherein the lens barrel and the first frame are configured to move in the optical axis direction together with the carrier.

11. A camera module comprising:
a housing unit having an internal space;
a carrier accommodated in the housing unit;
a first frame, accommodated in the carrier, and coupled to a lens barrel;
a stopper coupled to the carrier in an optical axis direction; and
a damper member provided on the housing unit and the stopper,
wherein the damper member comprises:
a first damper member and a second damper member disposed on the stopper and configured to face the housing unit and the first frame; and
a third damper member disposed on the housing unit and configured to face the carrier.

12. The camera module of claim 11, wherein:
the first damper member faces the housing unit and the first frame in the optical axis direction, and
the first damper comprises:
a first protrusion that protrudes from the stopper toward the housing unit in the optical axis direction and a second protrusion that protrudes from the stopper toward the first frame in the optical axis direction.

13. The camera module of claim 11, wherein:
the second damper member faces the housing unit and the first frame in a first axis direction, perpendicular to an optical axis, and
the second damper comprises:
a third protrusion that protrudes from the stopper toward the housing unit in the first axis direction and a fourth protrusion that protrudes from the stopper toward the first frame in the first axis direction.

14. The camera module of claim 11, wherein the third damper member faces the carrier in a second axis direction, perpendicular to an optical axis, and protrudes from one side of the housing unit toward the carrier in the second axis direction.

15. The camera module of claim 11, wherein the first damper member, the second damper member, and the third damper member are each provided as a separate member.

16. The camera module of claim 11, wherein:
the stopper comprises:
a body disposed to cover the first frame; and
a plurality of fastening portions coupled to the carrier, and extending from each corner of the body in the optical axis direction,
wherein the first damper member is disposed on the body, and the second damper member is disposed on at least a portion of the plurality of fastening portions.
